(19) United States
(12) Patent Application Publication
(10) Pub. No.: US 2025/0036932 A1
(43) Pub. Date: Jan. 30, 2025

(54) MULTI-VECTOR OPTICAL MULTIPLIER

(71) Applicant: HEWLETT PACKARD ENTERPRISE DEVELOPMENT LP, Spring, TX (US)

(72) Inventors: YUAN YUAN, Milpitas, CA (US); Xian XIAO, Santa Barbara, CA (US); Yiwei PENG, Spring, TX (US); Wayne Victor SORIN, Milpitas, CA (US); Stanley CHEUNG, Milpitas, CA (US); Zhihong HUANG, Milpitas, CA (US)

(21) Appl. No.: 18/359,540

(22) Filed: Jul. 26, 2023

(51) Int. Cl. G06N 3/067; G02F 1/21

(52) U.S. Cl. CPC G06N 3/067; G02F 1/212

(57) ABSTRACT

Systems and methods are provided for performing element-wise multi-vector multiplication. An example includes a waveguide to receive an input optical signal encoded with a first vector and output an output optical signal. One or more optical-to-electrical (O/E) converters are provided to receive one or more optical signals encoded with one or more vectors and generate one or more electrical signals based on the received one or more optical signals. One or more optical modulators are optically coupled to the waveguide and electrically coupled to the one or more O/E converters, the one or more optical modulators modulate an intensity of the input optical signal on the waveguide based on the one or more electrical signals. The output optical signal is encoded with a product of the first vector and the one or more vectors.

### BACKGROUND

In recent years, artificial neural networks (“ANNs”) have become a substantial tool for machine learning. ANNs benefit from application in a wide range of fields, such as, but not limited to, image recognition, natural language processing, and gaming, among others. For more complicated tasks, larger and deeper ANNs are becoming more important. These larger and deeper ANNs require faster and more energy-efficient computing hardware.

### BRIEF DESCRIPTION OF THE DRAWINGS

The present disclosure, in accordance with one or more various implementations, is described in detail with reference to the following figures. The figures are provided for purposes of illustration only and merely depict typical or example implementations.

FIG. 1 depicts a schematic block diagram of an optical multiplier 100 in accordance with the presently disclosed technology.

FIG. 2 depicts an example elementwise optical multiplier in accordance with the presently disclosed technology.

FIG. 3 depicts a schematic block diagram of an elementwise multiplication that can be performed using the examples of the presently disclosed technology.

FIG. 4A depicts an example schematic circuit of an optical-to-electrical converter driven optical modulator according to an example implementation of the presently disclosed technology.

FIG. 4B illustrates graphical representations of an example input signal current and an example voltage bias generated by the schematic circuit of FIG. 4A.

FIG. 5A depicts a schematic diagram of an overcoupled micro-ring assisted Mach-Zehnder interferometer that can be utilized in the examples of the presently disclosed technology.

FIG. 5B depicts a graphical representation of an intensity of an output optical signal as a function of phase shift in an example implementation of the overcoupled micro-ring assisted Mach-Zehnder interferometer of FIG. 5A.

FIG. 6 is an example computing component that may be used to implement various features of an elementwise optical multiplier in accordance with the implementations disclosed herein.

FIG. 7 is an example computer system that may be used to implement various features of an elementwise optical multiplier of the present disclosure.

The figures are not exhaustive and do not limit the present disclosure to the precise form disclosed.

### DETAILED DESCRIPTION

Examples of the presently disclosed technology provide for devices and methods for performing element-wise multiplication, i.e., Hadamard product. Implementations disclosed herein provide for optical multipliers capable of performing element-wise multiplication. The presently disclosed technology provides for high-speed, energy-efficient optoelectronic devices that can be utilized to produce an integrated and scalable optical multiplier. The disclosed technology provides for optical-input and optical-out that is fully compatible with optical neural networks (ONNs).

As alluded to above, ANNs can be a substantial tool for machine learning. As ANNs become larger and deeper, they require faster and more energy-efficient computing hardware. However, conventional electronic ANNs have several limitations, including high energy consumption, limited processing speed, and susceptibility to electromagnetic interference. As a result, ONNs have drawn increasing interest as ONNs rely on light to perform computations and information processing, rather than electronic signals. The reliance on light can overcome the above bottlenecks of electronic ANNs. For example, ultra-high-speed optoelectronic devices, such as photodiodes and modulators, can enable operation rates that are one to two orders of magnitude higher than electronic counterparts. Further, the reliance on light can provide ONNs that are resistant to electromagnetic interference, have no length-dependent resistance, and consume low energy. Thus, ONNs have been recognized as a competitive solution for more efficient hardware.

Many machine learning applications have a variety of data sources, including text, image, and audio data. Weighting and combining of data from multiple sources can complement the information from different modalities to obtain improved machine learning performance. For example, multimodal fusion networks can provide a robust performance from manifold data. Elementwise multiplication, also known as the Hadamard product, is an operation that combines different modalities/data into a single output. Electronic circuits can realize vector elementwise multiplication by using operational amplifiers and resistors. However, operational amplifiers only have a bandwidth of several kHz to tens of MHz. Additionally, these operation amplifiers are subject to high energy consumption in the range of a few μW to a few mW.

Some approaches have attempted to provide for elementwise multiplication using optoelectronic devices. Once approach provided a vector multiplier using balanced homodyne detection. In this case, two input data signals, represented by the electric field Ex and Ey, are injected into a beam splitter, and then detected by a balanced photodiode. The beam splitter mixes the two input data and the balanced PD detects a differential signal output from the beam splitter. The output current of the homodyne detection is proportional to the product of two input electric fields provided as Iₒᵤₜ=I₁−I₂=2R·Re[jE*_{\vec{X}}E_{\vec{Y}}], where R is the photodiodes responsivity. This approach can process the field multiplication of two optical vectors at high speed. However, since the vector multiplication originates from the optoelectronic effect, i.e., I_{PD}=R·P=R·|E|², this approach is valid only for two vectors. The homodyne detection cannot be extended to a multi-vector product, and so this approach is not sufficient for many machine learning applications. Additionally, this approach requires that the input data signals supplied to the beam splitter be encoded onto coherent optical signals of the same wavelength.

Against this backdrop, the technology disclosed herein provide for elementwise optical multipliers that offer improved operation bandwidth and reduced energy consumption. Since the disclosed technology provides for optical modulators that use an optical-input and provide an optical-output, it is fully compatible with existing ONNs. Furthermore, the disclosed technology can be utilized for elementwise multiplication of two or more vectors, and does not require coherency between input optical signals or common wavelengths.

Examples of the presently disclosed technology provide for optical multipliers for implementing a Hadamard product through an intensity multiplier for multiple vectors. Implementations disclosed herein may be particularly suited for elementwise multiplication of multiple vectors. Examples disclosed herein receive a plurality of vectors as encoded optical signals and output an output optical signal encoded with a vector that is the elementwise product of the input vectors. Each input vector is encoded into a distinct optical signal in the time domain. An input optical signal, encoded with a first vector, is injected into a waveguide comprising one or more optical modulators. In an illustrative example, each optical modulator comprises a Mach-Zehnder interferometer (“MZI”). The remaining optical signals are each encoded with the one of the remaining vectors and are injected into separate waveguides that terminate at respective optical-to-electrical (O/E) converters. O/E converters can be implemented as photodetectors (PDs) or similar devices. Each O/E converter is electrically connected to an optical modulator. In the illustrative example, each O/E converter is electrically connected to a phase shifter (PS) that is optically coupled to one of the optical modulators. Each O/E converter converts an encoded optical signal into an electrical signal, which is applied to the corresponding PS. The input optical signal, encoded with the first vector, is modulated by each optical modulator based on the corresponding PS driven by a corresponding electrical signal. For example, each O/E converter generates a photocurrent I_{PD} that is proportional to the square of the absolute value of the electrical field (|E|²) and by implementing a linear transformation between the phase shift (Δϕ) and the photocurrent (I_{PD}), the elementwise intensities of the other vectors can be multiplied onto the first vector. As a result, the resulting optical signal that is output from the waveguide is encoded with the elementwise product of the first vector with the other vectors. Due to the O/E converters that convert optical signals to electrical signals, each optical signal need not be coherent nor of the same wavelength. The optical signals can be the same or different wavelengths.

In an example implementation, the linear transformation is achieved by connecting a plurality of loaded resistors to the O/E converters. For example, a loaded resistor of the plurality of loaded resistors is connected to a corresponding O/E converter and converts the photocurrent from respective O/E converter to a voltage bias. The voltage bias is applied to the PS of each optical modulator, whose phase shift is proportional to the applied electric field. Thus, each optical modulator acts to modulate the intensity of the input optical signal according to one of the remaining vectors. As a result, the output optical signal is intensity modulated according to the elementwise product of the first vector with the other vectors.

To achieve the multiplication according to some examples, strongly overcoupled micro-ring assisted MZIs (RAMZIs) can be utilized as part of each optical modulator. For example, each signal detected by a O/E converter can be encoded to a PS optically coupled to a ring that is overcoupled to a respective MZI. As used herein “overcoupled” refers to evanescent coupling between waveguides having a high coupling coefficient. Coupling coefficient is a value between 0 and 1, where a value of 1 expresses perfect or 100% coupling of light from one waveguide to another waveguide. A high coupling coefficient may be, for example, a coupling coefficient of 0.89 or higher. In an example, the coupling coefficient may be between 0.84 and 0.94, which provides a deviation of less than 0.01 in coupling efficiency. In an illustrative example, a coupling coefficient for providing an illustrative strongly overcoupled ring may be a coupling coefficient of 0.92.

Due to the above, examples of the presently disclosed technology provide several advantages over the conventional devices. For example, by utilizing optoelectronic devices in an integrated system, improved efficiency can be achieved relative to providing separate optical systems and electronic chips. Furthermore, the examples disclosed herein can be scaled down to a compact size and can operate with low energy consumption. In addition, the disclosed technology can support a high data rate (e.g., on the order of tens to hundreds Gbit/s), which is determined by the bandwidth of O/E converters and PSs and both can obtain bandwidths of higher than 50 GHz. As a result, vectors can be encoded onto optical signals quickly. As another example, the presently disclosed technology provides a series structure that can be scaled up to any number of vectors for elementwise multiplication (e.g., by adding additional optical modulators and O/E converters). Therefore, any number of modalities or data sources can be combined by flexibly changing the number of O/E converter and optical modulator pairs. As yet another example advantage, the elementwise product can be computed passively via optical interference in the optical modulator (e.g., optical interference in the MZIs) at the speed of light, which is far faster than electric multipliers in terms of speed and energy consumption. In another example advantage, examples disclosed herein provide for an optical-input and optical-output structure, which can be inserted into any location of an ONN to meet the needs of different architectures.

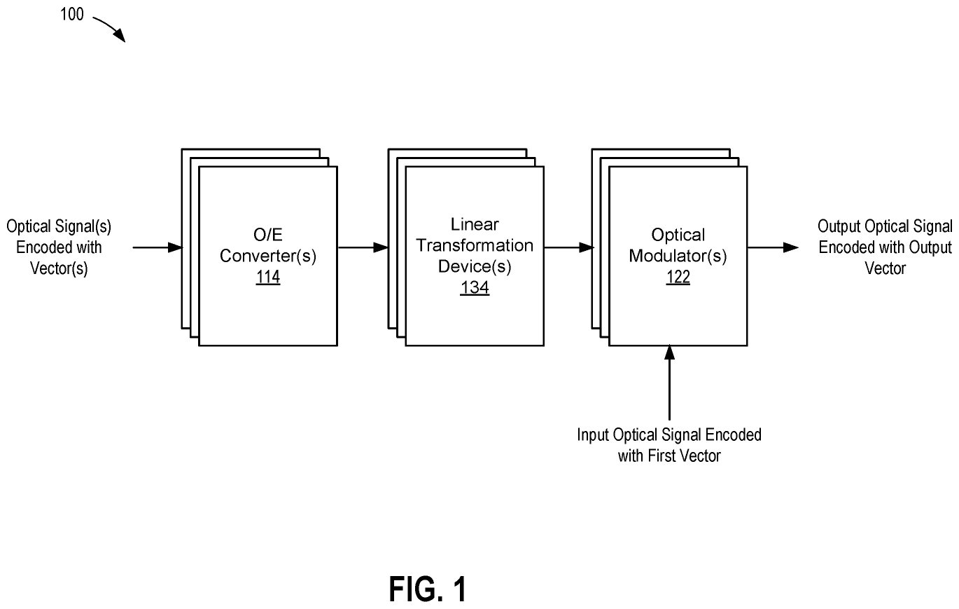

FIG. 1 depicts a schematic block diagram of an optical multiplier 100 in accordance with the presently disclosed technology.

The optical multiplier 100 comprises one or more O/E converters 114 that receive one or more optical signals encoded with one or more vectors. That is, each of the one or more O/E converters 114 receives a corresponding optical signal of the one or more optical signals. Each of the one or more O/E converters 114 is configured to generate an electrical signal based on the corresponding optical signal.

The optical multiplier 100 also comprises one or more optical modulators 122. Each of the one or more optical modulators 122 corresponds to one of the one or more O/E converters 114 and receives the electrical signal generated by the corresponding O/E converter 114. The optical modulators 122 also receive an input optical signal encoded with a first vector. Each optical modulator 122 is configured to modulate an intensity of the input optical signal based on corresponding electrical signal received from a corresponding O/E converter 114. The optical modulators 122 output an output optical signal encoded with an output vector that is an elementwise product of the first vector and the one or more vectors input into the O/E converters 114.

In various implementations, the optical multiplier 100 includes one or more linear transformation devices 134, each of which corresponds to one of the one or more O/E converters 114 and one of the one or more optical modulators 122 and are configured to implement a linear transformation on the electrical signal generated by the one or more O/E converters 114. In an example, the O/E converters 114 generate photocurrents and the one or more linear transformation devices 134 are configured to implement a transformation to convert the photocurrents into the voltage biases, which are applied to the one or more optical modulators 122. That is, each linear transformation device 134 converts a photocurrent from a corresponding O/E converter 114 to a voltage bias and applies the voltage bias to a corresponding optical modulator, which then modulates an intensity of the input optical signal based the received voltage bias.

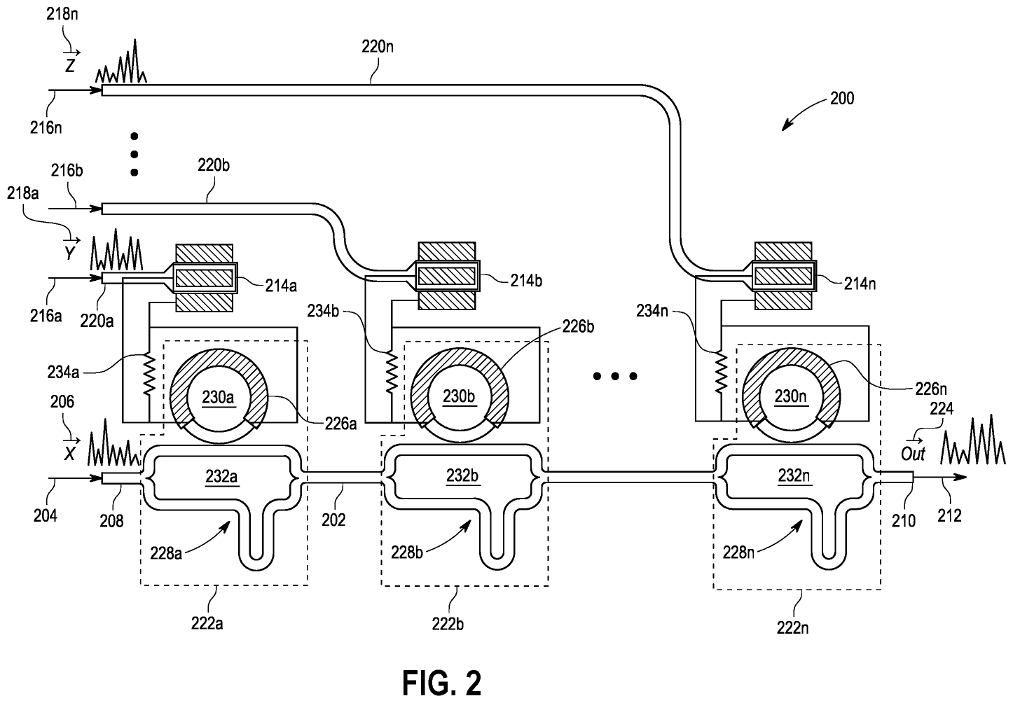

FIG. 2 depicts a schematic diagram of an example implementation of an elementwise optical multiplier 200 in accordance with the presently disclosed technology. Optical multiplier 200 may be implemented on Si platform in which the entire structure of optical multiplier 200 can be integrated into a single silicon on insulator (SOI) platform (e.g., a single photonic chip).

The optical multiplier 200 comprises an input waveguide 202 that receives an input optical signal 204 encoded with a first vector 206 an input end 208. Optical multiplier 200 also includes output end 210 that provides an output optical signal 212. Optical multiplier 200 includes one or more O/E converters 214a-214n (collectively referred to herein as “O/E converters 214”) to receive one or more optical signals 216a-n (collectively referred to herein as “optical signals 216”) encoded with one or more vectors 218a-n (collectively referred to herein as “vectors 218”). The one or more optical signals 216 are each injected into a waveguide 220a-n (collectively referred to herein as “waveguides 220”), each of which is optically coupled to a respectively corresponding O/E converter 214. The one or more O/E converters 214 each generate a voltage bias based on the optical signal 216 received by each respective O/E converter 214. Optical multiplier 200 also comprises one or more optical modulators 222a-n (collectively referred to herein as “optical modulators 222”), each of which is optically coupled to the waveguide 202 and electrically coupled to the a O/E converter 214. The one or more optical modulators 222 are configured to modulate an intensity of the input optical signal 204 propagating on the waveguide 202 based on the one or more voltage biases generated by the O/E converters 214. As a result, the output optical signal 212 is encoded with an output vector 224 that is an elementwise product of the first vector 206 and the one or more vectors 218.

In the example of FIG. 2, the one or more optical modulators 222 comprises one or more PS 226a-n (collectively referred to herein as “PS 226”) electrically coupled to the O/E converters 214. More particularly, each one or more optical modulators 222 comprises a corresponding PS 226 that is electrically coupled to a corresponding O/E converter 214, as shown in FIG. 2. Electrically coupled herein refers to a circuit pathway between two devices that provides for transfer of electrical energy from one device to another. The circuit pathways may be provided by conductive coupling, impedance matching, etc. The O/E converters 214 generate an electrical signal (e.g., a voltage bias or a current) based on the optical signals 216 received by each O/E converter. More particularly, an electrical signal generated by each O/E converters 214 can be proportional to an intensity of the optical signal 216 on the O/E converters 214. In various examples, the O/E converters 214 may be provided a photodetector, avalanche photodiode, balanced photodiode, and the like, which are configured to detect intensity as an amount of photons incident thereon and convert the photons to proportional electrical signals. The PS 226 disclosed herein may be provided as, but not limited to, phase shifters that leverage the Pockels Effect (e.g., a linear electrical-optical effect). These phase shifters may use non-centrosymmetric materials, such as, but not limited to, lithium niobate (LiNbO₃), lithium tantalate (LiTaO₃), β-barium borate (BBO), potassium titanium oxide phosphate (KTP), etc. Although these materials are not silicon, they can be integrated on silicon integrated circuits through bonding, transfer printing, etc.

The one or more optical modulators 222 can also comprise one or more MZIs 232a-n (collectively referred to herein as “MZIs 232”) optically coupled to the one or more PS 226. In the example implementation of FIG. 2, the one or more MZIs 232 are one or more RAMZIs 228a-n (collectively referred to herein as “RAMZIs 228”) comprising one or more MZIs 232 optically coupled to one or more micro-rings 230a-n (collectively referred to herein as “micro-rings 230”). More particularly, each one or more optical modulators 222 comprises a corresponding RAMZI 228 formed of a MZI 232 optically coupled to a micro-ring 230 comprising a corresponding PS 226 formed thereon, as shown in FIG. 2.

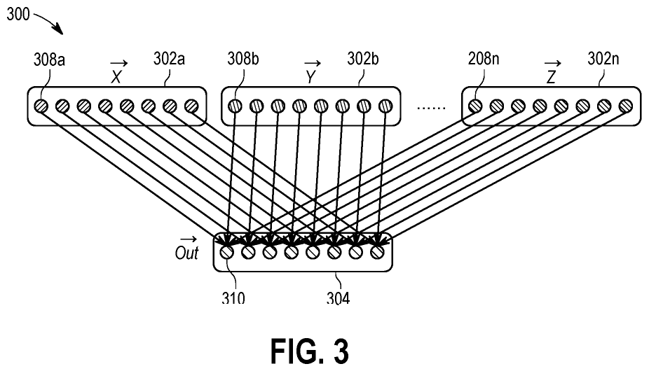

Optical multiplier 200 can be used for performing elementwise multiplication. FIG. 3 depicts an schematic block diagram of an elementwise multiplication that can be performed using the examples of the presently disclosed technology. More particularly, FIG. 3 illustrates vector elementwise multiplication, where each element of an output vector 304 (\vec{Out}) is a product of corresponding elements from a plurality of input vectors 302a-302n (e.g., \vec{X}, \vec{Y}, . . . \vec{Z}), where each input vector 302a-302n comprises a number of elements. That is, for example, a first element 308a of first input vector 302a (\vec{X}) is multiplied with first elements of the one or more other input vectors 302b-302n (\vec{Y}, \vec{Z}) to produce a first element 310 for the output vector 304 that is the product of the first elements 308a-308n. In the illustrative example of FIG. 3, each input vector 302a-302n are shown as N×1 vectors that produce a N×1 output vector 304, where N is 8. However, N can be any integer as desired for a given application.

With reference to FIG. 2, input vectors 302a-302n may be examples of first vector 206 and one or more vectors 218. That is, for example, first input vector 302a (\vec{X}) may be an example of first vector 206, while the one or more other input vectors 302b-302n (\vec{Y}, . . . \vec{Z}) may be examples of the one or more vectors 218. As such, output vector 304 (\vec{Out}) may be an example of output vector 224.

Returning to FIG. 2, during operation the input optical signal 204 is encoded with the first input vector 206 (e.g., first input vector 302a in one example) and one or more optical signals 216 are encoded with the one or more vectors 218 (e.g., one or more input vectors 302b-302n in one example) in the time domain. For example, the intensity of each optical signal can be modulated according to the elements of the corresponding vector used to encode the optical signal. As an illustrative example, an optical signal can be modulated to various intensity levels between 0 and a maximum, where 0 intensity may represent a 0 element value and a maximum intensity represents a maximum (or highest) element value of element values across all input vectors (e.g., across all of first vector 206 and one or more vectors 218). From there discrete intensity levels may be used to represent different element values. Then as a given optical signal propagates in the time domain, each intensity level may represent sequential element value (e.g., a first intensity in time represents a value of a first element, a second intensity level in time represents a value of a second element, and so on). Once encoded, the input optical signal 204 can be injected, either directly or indirectly, the one or more optical modulators 222 and the one or more optical signals 216 are each injected into separate O/E converters 214. The O/E converters 214 convert the encoded optical signals 216 into electric signals, where each O/E converter 214 is electrically connected to a separate PS 226. The input optical signal 204 is modulated by one or more optical modulators 222 via the PSs 226 to generate output optical signal 212 and output vector 224 to obtain the product of the one or more one or more vectors 218.

As alluded to above, example disclosed herein can leverage intensity modulation of optical signals 204 and 216 to perform the elementwise multiplication. For example, each O/E converter 214 can be provided such that the photocurrent I_{PD} generated by the O/E converter 214 is proportional to the electric field (E) applied to the O/E converters 214 by a received optical signal 216 (e.g., I_{PD}∝|E|²). This proportionality can be derived from an optoelectronic effect, i.e., I_{PD}=R·P=R·|E|², where P is optical power incident on the detector and R is the responsivity of the O/E converter 214. Responsivity can be defined as an output electrical signal (typically current) of a detector produced in response to a given incident radiant power falling on the detector. Optical multiplier 200 can be provided to implement a linear transformation between a phase shift (Δϕ) applied by the PS 226 to input optical signal 204 and the photocurrent (I_{PD}) generated by the O/E converter 214, which can be used to multiply the elements of the optical signal 216 onto first vector 206 using encoded intensities as received by the O/E converters 214.

There are many methods that can achieve the linear transformation between Δϕ and I_{PD}. For example, the one or more O/E converters 214 are electrically connected to one or more linear transformation devices 234a-n, which are configured to convert photocurrents I_{PD} generated by the one or more O/E converters 214 to the voltage biases V_{PS}. The voltage bias (V_{PS}) can be applied to a corresponding PS 226, whose phase shift (Δϕ) can be proportional to its electric field (E_{PS}) that is applied an optical signal (e.g., input optical signal 204). As described above, the PS 226 may leverage the Pockels Effect and comprise non-centrosymmetric materials, such as, but not limited to, LiNbO₃, LiTaO₃, BBO, KTP, etc.

In an illustrative example of optical multiplier 200, the one or more linear transformation devices 234a-n may be implemented as one or more load resistors 234a-n (collectively referred to herein as load resistors 234), which can assist with providing for the linear transformation. Each load resistor 234 can operate to convert photocurrent I_{PD} generated by each corresponding O/E converter 214 to a voltage bias (V_{PS}) that can be applied to a corresponding PS 226, whose phase shift (Δϕ) can be proportional to its electric field (E_{PS}) that is applied an optical signal (e.g., input optical signal 204). That is, for example, the phase shift (Δϕ) of PS 226 can be proportional to the electric field applied by the corresponding PS 226 to input optical signal 204, which is proportional to the voltage bias (V_{PS}) generated by the O/E converter 214 and applied to the PS 226. The voltage bias (V_{PS}) generated by the O/E converter 214 is proportional to the resistance (r_{load}) multiplied by the photocurrent (I_{PD}) generated by the O/E converters 214, which is proportional to the absolute value of the electric field incident on the O/E converters 214 (e.g., Δϕ∝E_{PS}∝V_{PS}∝R_{load}·I_{PD}∝|E|²). Thus, for each one or more optical modulators 222 and O/E converters 214 pair, the parameters of the various attributes of the one or more optical modulators 222 and O/E converter 214 can be selected to provide for the linear transformation accordingly.

In an example implementation, optical multiplier 200 can provide for capability to weigh each vector 206 and 218. For example, using avalanche photodiodes (APDs) for the O/E converters 214, an extra avalanche gain can be achieved for the photocurrent generated by each O/E converter 214. This extra avalanche gain can be used as for weighting each vector on the optical modulator 222. Therefore, weights can be applied to different vectors by adjusting the avalanche gain. For example, a first weight may be applied by adjusting the avalanche gain for O/E converter 214a and a second weight applied by adjusting the avalanche gain for O/E converter 214b. If the first weight is larger than the second weight, then the modulation of the intensity on the input optical signal 204 due to optical modulator 222a will be larger than that exerted by the optical modulator 222b.

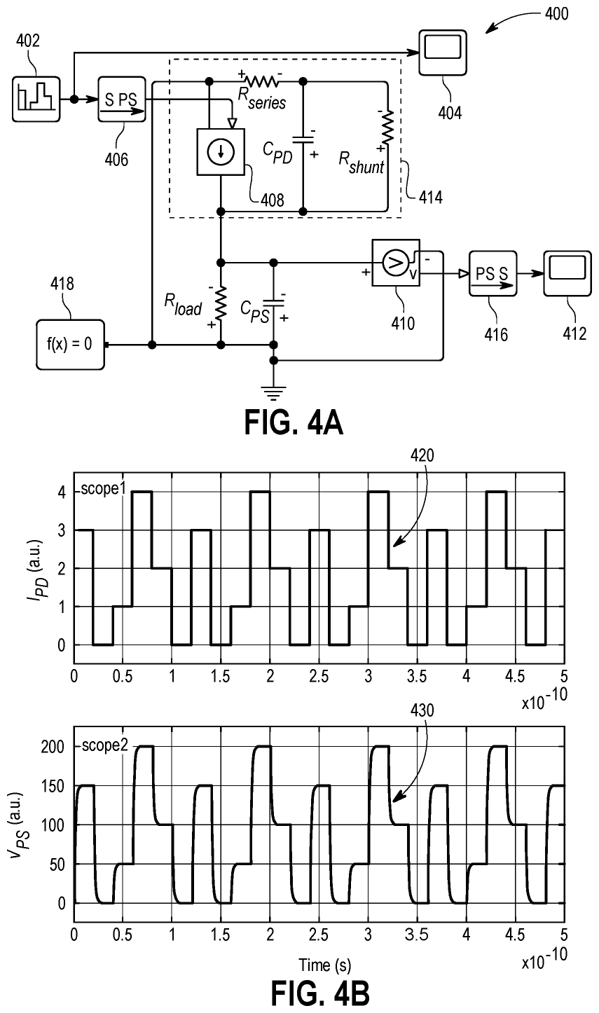

FIG. 4A depicts an example schematic circuit 400 of a O/E converter driven optical modulator according to an example implementation of the presently disclosed technology.

Schematic circuit 400 is an example simulation of an implementation of an O/E converter 214 electrically connected to a one or more optical modulator 222. For example, an encoded signal 402 (e.g., a vector 218) is provided to a first scope 404 (e.g., an oscilloscope) and to a Simulink to physical signal (PS) converter (S PS) 406, which converts a Simulink input signal into physical signal. The S PS 406 outputs a signal that is a simulation of an optical signal 216, which is provided to a circuit 414, which is an example circuit of a photodiode (e.g., a O/E converter 214). The circuit 414 comprises a current source 408 connected in series to a series resistor Rₛₑᵣᵢₑₛ and in parallel to a capacitor C_{PD} and shunt resistor Rₛₕᵤₙₜ. An output of current source 408 is connected to a negative terminal of a load resistor R_{load} (e.g., an example of a load resistor 234), which is also connected to positive terminals of C_{PD} and Rₛₕᵤₙₜ as shown in FIG. 4A. The negative terminal of R_{load} is also connected to a positive terminal voltage sensor 410 and connected in parallel to a capacitor C_{PS}. The positive terminals of R_{load} and C_{PS} are connected to a solver configuration block (f(x)) 418 and to ground, along with a negative terminal of the voltage sensor 410. The solver configuration block specifies the solver parameters that a model needs before simulation can begin. The voltage sensor 410 outputs a voltage to PS to Simulink converter (PS S) 416 connected to a second scope 412 (e.g., an oscilloscope). The capacitor C_{PS} is used to simulate a PS 226.

FIG. 4B illustrates graphical representations of an example input signal current and an example voltage bias generated by the schematic circuit 400 of FIG. 4A. More particularly, FIG. 4B depicts a input photocurrent signal 420 plotted as IPD as a function of time, which is representative of the encoded signal 402 supplied to the circuit 414, as monitored by first scope 404. In this example, the encoded signal 402 may be provided as a vector have element values of 3, 0, 1, 4, 2, and so on. FIG. 4B also depicts a voltage bias signal 430 across C_{PS} detected by voltage sensor 410 as monitored by second scope 412, which is illustrative of a voltage bias applied to a PS 226 of FIG. 2.

In operation, an input photocurrent detected by circuit 414 is encoded with the signal 402. This photocurrent is monitored by first scope 404, which provides input photocurrent signal 420. Current source 408 generates an output photocurrent that passes through R_{load} and C_{PS}. The voltage across the C_{PS} is monitored by second scope 412, which provides voltage bias signal 430. In an example simulation, FIG. 4B shows a voltage across C_{PS} at 50 Gbit/s, where C_{PD} is 10 fF, Rₛₕᵤₙₜ is 200 MΩ, Rₛₑᵣᵢₑₛ is 50Ω, R_{load} is 50Ω, and C_{PS} is 10 fF. As shown in FIG. 4B, the input photocurrent I_{PD} is proportional to the voltage bias across C_{PS}. Thus, information encoded into the input signal incident on circuit 414 can be transferred to the voltage bias applied to C_{PS}.

Accordingly, with reference to FIG. 2, information encoded onto an optical signal 216, incident on a O/E converters 214, can be transferred to a voltage bias generated by O/E converters 214 that can be applied to PS 226 for driving an optical modulator 222. Furthermore, FIGS. 4A and 4B demonstrate that optical multiplier 200 can support a very high data rate, for example, 50 Gbit/s, which is much higher than the data rate that is achievable using the counterpart electronic systems.

As alluded to above, examples of the presently disclosed technology can utilize a overcoupled RAMZI in the optical modulators 222 to provide for intensity modulation of input optical signal 204. In this case, a O/E converter 214 encodes an electrical signal (e.g., voltage bias) based on the optical signal 216 incident thereon, which is applied to a corresponding PS 226 provided on a micro-ring 230 that is overcoupled to a MZI 232. By modulating the electrical field applied by the PS 226 based on modulating the voltage bias applied thereto, the PS 226 exerts a phase shift on input optical signal 204 that is evanescently overcoupled into micro-ring 230 from the MZI 232. The modulating phase shift imparted by PS 226 induces an intensity modulation at an output of the MZI 232 that is proportional to and corresponds to the intensity modulation of the optical signal 216 incident on O/E converters 214. As optical signal 216 is encoded with a vector 218, the resulting optical signal that is output from MZI 232 is encoded with a output vector that is an element wise product of the vector 218 and the first vector 206 encoded on the input optical signal 204.

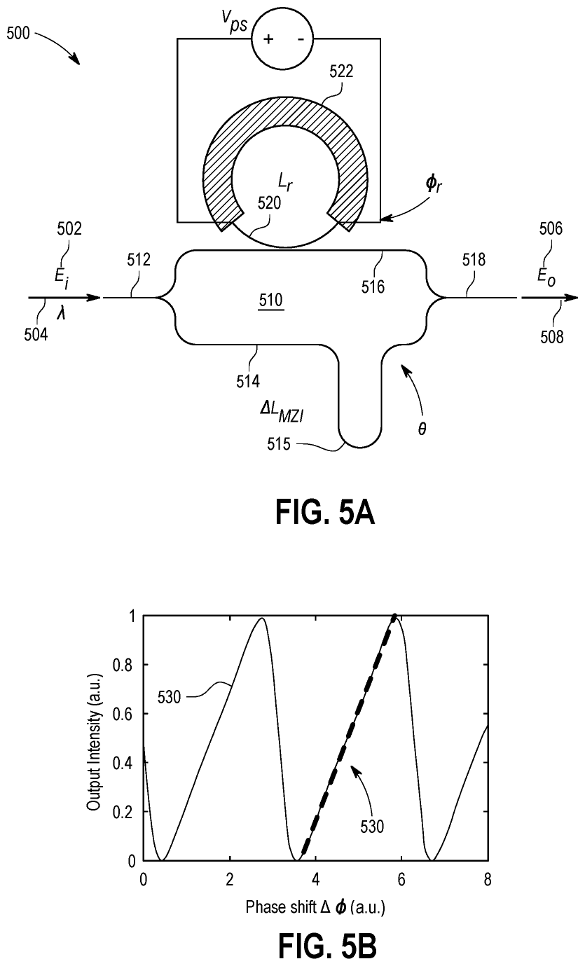

FIG. 5A depicts a schematic diagram of an overcoupled RAMZI 500 that can be utilized in the examples of the presently disclosed technology.

Overcoupled RAMZI 500 can comprise a MZI 510 that is evanescently coupled to a micro-ring 520. The overcoupled RAMZI 500 includes an input end 512 that receives an input optical signal 502 having an input electric field E; and propagating with a wavelength A. Optical signal 502 may be encoded according to a vector. Overcoupled RAMZI 500 comprises an output end 518 that transmits an output optical signal 506, having an output electric field Eₒ. The MZI 510 receives the input optical signal 502 from the input end, which is split into a first branch 516 and a second branch 514 according to a splitting ratio. The MZI 510 may be implemented as one or more waveguides that guide the propagation of the input optical signal 502. For example, first branch 516 may be formed of a first waveguide and second branch 514 may be formed of a second waveguide. The micro-ring 520 is optically coupled to one of the branches (e.g., first branch 516 in this example), while the other branch includes at delay line 515. Delay line 515 may be provided as a difference in length between second branch 514 and first branch 516, for example, by increasing the length of second branch 514 relative to second branch 514 by ΔL_{MZI}.

Examples disclosed herein may include an optical splitter provided at the input end 512 for coupling portions of input optical signal 502 into each branch 514 and 516. The optical splitter may be implemented as a Y-splitter for splitting the input optical signal 502 into branches 514 and 516 according to a splitting ratio of the optical splitter. For example, the optical splitter may operate to split input optical signal 502 into first optical signal that propagates in first branch 516 and a second optical signal that propagates in a second branch 514. The relative optical power of the first and second signals is dependent on the splitting ratio of the optical splitter. In the illustrative examples provided herein, the optical splitter can be a 50:50 Y-splitter having a splitting ratio of 1, which means the optical power of the first and second signals is approximately the same (e.g., 50% of input optical signal 502 is guided into branch 514 and 50% is guided into branch 516). However any splitting ratio may be utilized as desired for a given application. An optical coupler may be provided at output end 518, which may be similar but opposite to that of the optical splitter. That is, for example, the optical coupler may operate to combine optical signals propagating in second branch 514 and first branch 516 into onto output end 518 as output optical signal 506.

The optical signal on first branch 516 is optically coupled into micro-ring 520, for example, through evanescent coupling based on a coupling coefficient between the waveguide of the first branch 516 and a waveguide of the micro-ring 520. According to various implementations disclosed herein, the waveguides forming the MZI 510 and the waveguide forming the micro-ring 520 are made from the same material, for example, silicon. As described above, the micro-ring 520 may be strongly overcoupled to the first branch 516 such that the coupling coefficient between the micro-ring 520 and first branch 516 is high (e.g., at least greater than 0.89).

In the micro-ring 520, phase-shift 522 can be controlled to tune the resonance frequency, thereby inducing a phase-shift applied to an optical signal resonating in the micro-ring 520. As described above, a voltage bias (Vₚₛ) can be applied to the phase-shift 522, which modulates the electric field (Eₚₛ) on the phase-shift 522. This change in the electric field then modulates the phase of the optical signal resonating in the micro-ring 520.

The MZI 510 then converts the phase shift in the optical signal from the micro-ring 520 into an intensity change. For example, optical signals propagating in the two branches 514 and 516 can combine in output end 518 resulting in constructive and/or destructive interference, leading to changes in intensity of the output optical signal 506. Where overcoupled RAMZI 500 is implemented as a one or more optical modulators 222 driven by voltage bias from a O/E converter 214, the intensity changes in output optical signal 506 over time can be decoded as elements of output vector (e.g., output vector 224) that is a product of an optical signal 216 multiplied with input optical signal 204.

Referring to FIG. 5A in more detail, phase-shift 522 is coupled to the micro-ring 520 and a roundtrip phase of micro-ring 520 can be provided as:

$${ϕ}_{r} = ( \frac{2 π ( n + Δ n )}{λ} ) {L}_{r} \qquad Eq . 1$$

where n is the index of refraction of the waveguide forming micro-ring 520, An is the change in effective refractive index due to the phase shift cause by phase-shift 522 (e.g., phase change from tuning the phase-shift 522), Lᵣ is the circumference of phase-shift 522, and λ is wavelength of input optical signal 502. Additionally, a mπ+π/2 phase difference may exist between the two branches 514 and 516 due difference in branch length (e.g., delay line 515), excluding the circumference of micro-ring 520. As a result, the phase difference between the two branches 514 and 516 can be provided as:

$$θ = ( \frac{2 π n}{λ} ) Δ {L}_{MZI} = m π + π / 2 \qquad Eq . 2$$

where ΔL_{MZI} is the branch length difference in lengths of the first branch and second branch, and m is 0, 1, 2, 3, etc.

Therefore, the output electric field of output optical signal 506 of overcoupled RAMZI 500 can be provided as:

$${E}_{o} = \frac{{E}_{i}}{2} [ exp ( j ( π + {ϕ}_{r} ) ) \frac{a - t exp ( - j {ϕ}_{r} )}{1 - at exp ( - j {ϕ}_{r} )} + exp ( j θ ) ] \qquad Eq . 3$$

where Et is the input electric field, a is the roundtrip field transmission of the micro-ring 520, and t is the field transmission of the coupling between micro-ring 520 and first branch 516. For lossless couplers, t²+κ²=1, where κ is the field coupling coefficient. For an illustrative strongly overcoupled micro-ring 520, a may be 0.99 and κ may be between than 0.89 and 0.94, and in implementation example k may be 0.92.

FIG. 5B depicts a graphical representation of the intensity of output optical signal 506, which can be provided as |Eₒ|², as a function of phase shift Δϕ in an example implementation of overcoupled RAMZI 500. As shown in FIG. 5B, the linearity of overcoupled RAMZI 500 can be quantified by a linear regression, shown as the dashed line 530 in FIG. 5B. Thus, as shown in FIG. 5B, overcoupled RAMZI 500 provides for a linear transformation (e.g., proportionality) between the phase shift Δϕ and the intensity of output optical signal 506. Furthermore, overcoupled RAMZI 500 exhibits a very small standard deviation σ of approximately 0.007, which corresponds to a 7-bit precision. Due to the high precision, the linearized overcoupled RAMZI 500 can be leverage for encoding analog signals, for example, from O/E converters 214, without any additional control circuitry.

While an overcoupled RAMZI is described here as used for optical modulators, the presently disclosed technology is not so limited. The optical modulators disclosed herein may be implemented using other techniques and devices, such as but not limited to, ring resonators and conventional MZIs.

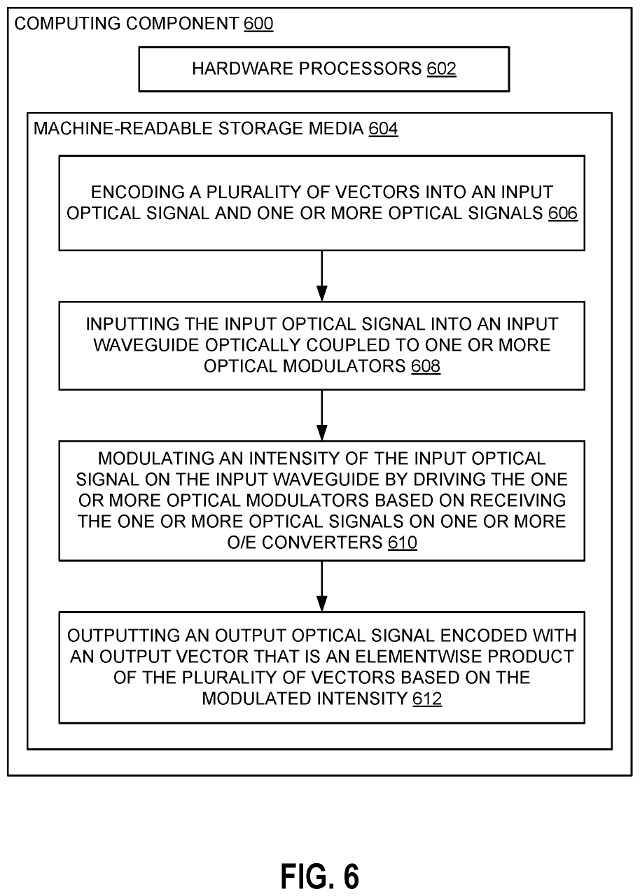

FIG. 6 illustrates an example computing component that may be used to implement elementwise optical multiplication in accordance with various implementations of the disclosed technology. Referring now to FIG. 6, computing component 600 may be, for example, a server computer, a controller, or any other similar computing component capable of processing data. In the example implementation of FIG. 6, the computing component 600 includes a hardware processor 602, and machine-readable storage medium for 604.

Hardware processor 602 may be one or more central processing units (CPUs), semiconductor-based microprocessors, and/or other hardware devices suitable for retrieval and execution of instructions stored in machine-readable storage medium 604. Hardware processor 602 may fetch, decode, and execute instructions, such as instructions 606-612, to control processes or operations for elementwise multiplication. As an alternative or in addition to retrieving and executing instructions, hardware processor 602 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 604, may be any electronic, magnetic, optical, or other physical storage device that contains or stores executable instructions. Thus, machine-readable storage medium 604 may be, for example, Random Access Memory (RAM), non-volatile RAM (NVRAM), an Electrically Erasable Programmable Read-Only Memory (EEPROM), a storage device, an optical disc, and the like. In some implementations, machine-readable storage medium 604 may be a non-transitory storage medium, where the term “non-transitory” does not encompass transitory propagating signals. As described in detail below, machine-readable storage medium 604 may be encoded with executable instructions, for example, instructions 606-612.

Hardware processor 602 may execute instruction 606 to encode a plurality of vectors into an input optical signal and one or more optical signals. For example, as described above in connection with FIGS. 1, 2, and 5A, a number of vectors may be encoded into various optical signals for use in performing elementwise multiplication.

Hardware processor 602 may execute instruction 508 to input the input optical signal into an input waveguide optically coupled to one or more optical modulators. For example, as described above in connection with FIGS. 1 and 2, the input optical signal is injected into an input waveguide. As described above in connection with FIGS. 1 and 2, the input waveguide may comprises one or more optical modulators optically coupled there to.

Hardware processor 602 may execute instruction 610 to modulate an intensity of the input optical signal on the input waveguide by driving the one or more optical modulators based on receiving the one or more optical signals on one or more optical-to-electrical (O/E) converters. For example, as described above in connection with FIGS. 1, 2 and 4A-5B, one or more photocurrents can be generated based on the one or more optical signals received on the one or more O/E converters. The one or more photocurrents can be converted to one or more voltage biases, which can be used to drive the one or more optical modulators. The one or more O/E converters can be electrically coupled to one or more linear transformation devices that convert the one or more photocurrents to one or more voltage biases. The one or more voltage biases can be applied one or more phase shifters coupled to the one or more optical modulators, and the one or more optical modulators can modulate the intensity of the input optical signal based on phase shifts applied by the one or more phase shifters to the input optical signal. The input optical signal can be coupled to the one or more phase shifters through one or more micro-rings overcoupled to one or more Mach-Zehnder interferometers.

Hardware processor 602 may execute instruction 612 to output an output optical signal encoded with an output vector that is an elementwise product of the plurality of vectors. For example, as described above, modulating the intensity of the input optical signal at instruction 610 encodes an elementwise product of the plurality of vectors onto the input optical signal, such that the output optical signal is encoded with this product.

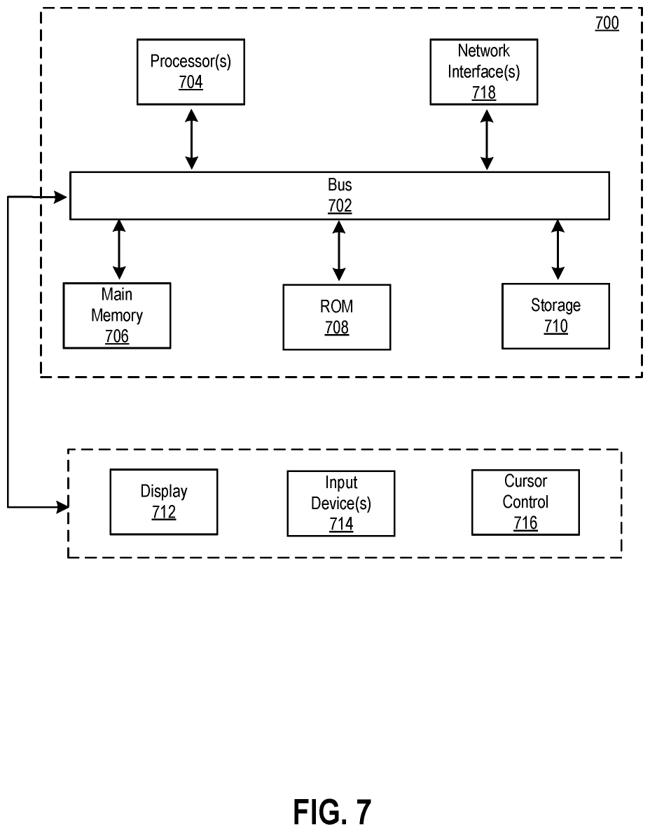

FIG. 7 depicts a block diagram of an example computer system 700 in which various of the implementations described herein may be implemented. The computer system 700 includes a bus 702 or other communication mechanism for communicating information, one or more hardware processors 704 coupled with bus 702 for processing information. Hardware processor(s) 704 may be, for example, one or more general purpose microprocessors. The computer system 700 may be implemented as computing component 600 of FIG. 6.

The computer system 700 also includes a main memory 706, such as a random access memory (RAM), cache and/or other dynamic storage devices, coupled to bus 702 for storing information and instructions to be executed by processor 704. Main memory 706 also may be used for storing temporary variables or other intermediate information during execution of instructions to be executed by processor 704. Such instructions, when stored in storage media accessible to processor 704, render computer system 700 into a special-purpose machine that is customized to perform the operations specified in the instructions.

The computer system 700 further includes a read only memory (ROM) 708 or other static storage device coupled to bus 702 for storing static information and instructions for processor 704. A storage device 710, such as a magnetic disk, optical disk, or USB thumb drive (Flash drive), etc., is provided and coupled to bus 702 for storing information and instructions.

The computer system 700 may be coupled via bus 702 to a display 712, such as a liquid crystal display (LCD) (or touch screen), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. In some implementations, the same direction information and command selections as cursor control may be implemented via receiving touches on a touch screen without a cursor.

The computing system 700 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 700 may implement the techniques described herein using customized hard-wired logic, one or more ASICs or FPGAs, firmware and/or program logic which in combination with the computer system causes or programs computer system 700 to be a special-purpose machine. According to one implementation, the techniques herein are performed by computer system 700 in response to processor(s) 704 executing one or more sequences of one or more instructions contained in main memory 706. Such instructions may be read into main memory 706 from another storage medium, such as storage device 710. Execution of the sequences of instructions contained in main memory 706 causes processor(s) 704 to perform the process steps described herein. In alternative implementations, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 710. Volatile media includes dynamic memory, such as main memory 706. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 702. Transmission media can also take the form of acoustic or light waves, such as those generated during radio-wave and infra-red data communications.

The computer system 700 also includes a communication interface 718 coupled to bus 702. Network interface 718 provides a two-way data communication coupling to one or more network links that are connected to one or more local networks. For example, communication interface 718 may be an integrated services digital network (ISDN) card, cable modem, satellite modem, or a modem to provide a data communication connection to a corresponding type of telephone line. As another example, network interface 718 may be a local area network (LAN) card to provide a data communication connection to a compatible LAN (or WAN component to communicated with a WAN). Wireless links may also be implemented. In any such implementation, network interface 718 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through communication interface 718, which carry the digital data to and from computer system 700, are example forms of transmission media.

The computer system 700 can send messages and receive data, including program code, through the network(s), network link and communication interface 718. In the Internet example, a server might transmit a requested code for an application program through the Internet, the ISP, the local network and the communication interface 718.

The received code may be executed by processor 704 as it is received, and/or stored in storage device 710, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example implementations. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAS, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 700.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain implementations include, while other implementations do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. An optical device, comprising:
a waveguide to receive an input optical signal encoded with a first vector, and output an output optical signal;
one or more optical-to-electrical (O/E) converters to receive one or more optical signals encoded with one or more vectors and generate one or more electrical signals based on the received one or more optical signals;
one or more optical modulators optically coupled to the waveguide and electrically coupled to the one or more O/E converters, the one or more optical modulators to modulate an intensity of the input optical signal on the waveguide based on the one or more electrical signals; and
wherein the output optical signal is encoded with a product of the first vector and the one or more vectors.

2. The optical device of claim 1, wherein the one or more O/E converters are photodetectors.

3. The optical device of claim 1, wherein each of the one or more optical modulators comprises:
a phase shifter electrically coupled to a respective O/E converter; and
a Mach-Zehnder interferometer (MZI) optically coupled to the waveguide and to the phase shifter.

4. The optical device of claim 3, further comprising:
one or more linear transformation devices electrically connected to and between the one or more O/E converters and the one or more optical modulators, wherein the one or more linear transformation devices are configured to convert photocurrents generated by the one or more O/E converters to the one or more electrical signals, wherein the phase shifters are configure to apply a phase change that is proportional to the one or more electrical signals.

5. The optical device of claim 4, wherein the one or more linear transformation devices are one or more resistors.

6. The optical device of claim 3, wherein the MZI comprises a micro-ring assisted MZI (RAMZI), wherein the phase shifter is disposed on a micro-ring of the RAMZI.

7. The optical device of claim 6, wherein the micro-ring is overcoupled to the MZI.

8. The optical device of claim 7, wherein a coupling coefficient between the micro-ring and the MZI is between 0.89 and 0.94.

9. The optical device of claim 3, wherein the MZI comprises a first branch, a second branch, and a branch length difference between lengths of the first branch and the second branch.

10. The optical device of claim 1, wherein the one or more O/E converters comprises at least:
a first O/E converter to receive a first optical signal encoded with a second vector, and
a second O/E converter to receive a second optical signal encoded with a third vector,
wherein the output optical signal is encoded with an elementwise product of the first vector and the second and third vectors.

11. The optical device of claim 9, wherein the one or more optical modulators comprises at least:
a first optical modulator optically coupled to the waveguide and electrically coupled to the first O/E converter, and
a second optical modulator optically coupled to the waveguide and electrically coupled to the second O/E converter.

12. A method for elementwise vector multiplication, the method comprising:
encoding a plurality of vectors into an input optical signal and one or more optical signals;
inputting the input optical signal into an input waveguide optically coupled to one or more optical modulators;
modulating an intensity of the input optical signal on the input waveguide by driving the one or more optical modulators based on receiving the one or more optical signals on one or more optical-to-electrical (O/E) converters; and
outputting an output optical signal encoded with an output vector that is an elementwise product of the plurality of vectors based on the modulated intensity.

13. The method of claim 11, further comprising:
generating one or more photocurrents based on the one or more optical signals received on the one or more O/E converters;
converting the one or more photocurrents to one or more electrical signals; and
driving the one or more optical modulators based on the one or more electrical signals.

14. The method of claim 12, wherein the one or more O/E converters are electrically coupled to one or more linear transformation devices that convert the one or more photocurrents to one or more electrical signals.

15. The method of claim 12, wherein driving the one or more optical modulators based on the one or more electrical signals comprises:
applying the one or more electrical signals to one or more phase shifters coupled to the one or more optical modulators;
wherein the one or more optical modulators modulate the intensity of the input optical signal based on one or more phase shifts applied by the one or more phase shifters to the input optical signal, wherein the input optical signal is optically coupled to the one or more phase shifters.

16. The method of claim 14, wherein the one or more optical modulators comprise one or more micro-rings overcoupled to one or more Mach-Zehnder interferometers, wherein the one or more phase shifters are coupled to the one or more micro-rings.

17. The method of claim 14, wherein the one or more phase shifts are proportional to the one or more electrical signals, the one or more photocurrents, and the modulated intensity.

18. A elementwise multi-vector optical multiplier, comprising:
a waveguide configured to receive an input optical signal encoded with a first vector and to output an output optical signal, the waveguide comprising a micro-ring optically coupled to a Mach-Zehnder interferometer (MZI);
a phase-shifter coupled to the micro-ring; and
a photodiode electrically coupled to a the phase-shifter via a linear transformation device, the photodiode configured to receive an optical signal encoded with a second vector,
wherein the output optical signal is encoded with a elementwise product of the first vector and the second vector.

19. The multi-vector optical multiplier of claim 18, wherein the linear transformation device is a resistor, the resistor being electrically coupled to the phase-shifter and the photodiode.

20. The multi-vector optical multiplier of claim 18, wherein a coupling coefficient between the micro-ring and the MZI is between 0.89 and 0.94.
